(19) United States
(12) Patent Application Publication
(10) Pub. No.: US 2006/0292492 A1
(43) Pub. Date: Dec. 28, 2006

(54) Optical information recording medium and optical information reproducing apparatus

(75) Inventors: Shuichi Ohkubo, Tokyo (JP); Yutaka Yamanaka, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/474,983

(22) Filed: Jun. 27, 2006

(30) Foreign Application Priority Data
Jun. 27, 2005 (JP) 2005-187162

(51) Int. Cl. G11B 7/24

(52) U.S. Cl. 430/270.11

(57) ABSTRACT

In an optical information recording medium to which a recording operation or reproducing operation of information is carried out by irradiating a laser beam, there are provided with two recording layers provided through a space layer. An absolute value of a change Δd of a film thickness of the space layer for every unit length in a circumferential direction is equal to or less than a predetermined value which is determined based on a wavelength of the laser beam, a refractive index of the space layer in the wavelength λ and one of a line velocity of the laser beam and the shortest pit length in a pit sequence recorded in each of the recording layers.

### BACKGROUND OF THE INVENTION

1. Field of the Invention

The present invention relates to an optical information recording medium and an optical information reproducing apparatus, and more particularly, a multi-layer optical information recording medium in which in which recording and reproduction operations of data from a plurality of recording layers are carried out through irradiation of a laser beam, and an optical information reproducing apparatus for the multi-layer optical information recording medium.

2. Description of the Related Art

In a rewritable optical information recording medium such as a magneto-optic disc and a phase change optical disc, a laser beam is irradiated to a recording film. A data is recorded by changing the optical characteristic of the recording film such as a magneto-optic characteristic, a reflectance, and an optical phase with the laser beam, and the data is reproduced from the laser beam which is modulated in accordance with the optical characteristic of the recording film.

In order to increase a recording capacity of the optical information recording medium, various techniques are recently tried such as a signal processing technique, a land and groove recording technique in which data is recorded on both of a portion corresponding to a tracking guide groove formed in a substrate and a portions between the guide grooves, and a super resolution reproduction which allows the reproduction of a mark smaller than an optically diffractive limit. Among those techniques, a multi-layer recording medium which has multiple recording layers, especially, a 2-layer medium which uses two recording layers can greatly increase the recording capacity. Thus, its research and development has been vigorously advanced. The capacity of the 2-layer medium has a possibility of being simply increased to two times at a maximum as compared with the single-layer recording medium. Actually, in DVD-ROM in which a red semiconductor laser beam is used, a disc having the capacity of 4.7 GB in case of a single layer and a disc having the capacity of 9 GB which is about two times are commercially available.

FIG. 2 is a sectional view showing a section of the multi-layer optical information recording medium. In a configuration example of FIG. 2, a plurality of recording layers (a total of (N+1) layers in the example of FIG. 2) are laminated through space layers on a substrate. In this specification, the respective recording layers are assumed to be identified in order in such a manner that the recording layer on the closest side to an input plane of the laser beam is referred to as L0, the second recording layer from the laser beam input plane is referred to as L1, and the subsequent recording layer is referred to as L2. The space layer plays a role for adhering the two recording layers and also plays a role for decreasing crosstalk between the recording layers. Here, the crosstalk between the recording layers implies a reflection light component from a different layer in a reproduction signal from a predetermined recording layer, as shown in FIG. 3. The crosstalk between the recording layers becomes a factor that decreases a modulation degree of the reproduction signal and deteriorates the quality of the reproduction signal. As the space layer is thicker, the crosstalk between the recording layers can be decreased. On the other hand, as the space layer is thicker, the spherical aberration of a focused beam that is used to record or reproduce data is increased to deteriorate the quality of the reproduction signal. Thus, the thickness of the space layer is required to be optimized by considering the tradeoff of the decrease in the crosstalk between the recording layers and the increase in the spherical aberration.

In conjunction with the above description, a method of manufacturing a multi-layer optical recording medium is disclosed in Japanese Laid Open Patent Publication (JP-P2003-77191A). In the conventional manufacturing method of the multi-layer optical recording medium, a first optical recording plane is formed on a substrate. A light transmitting intermediate layer is formed on a first optical recording plane through at least twice of a laminating step. Then, a second optical recording plane is formed on the light transmitting intermediate layer.

Also, a method of manufacturing an optical recording medium is disclosed in Japanese Laid Open Patent Publication (JP-P2003-296978A). In the conventional manufacturing method of the optical recording medium, a substrate is produced to have a first minute unevenness. A first optical recording layer is formed on the substrate, an ultraviolet-ray hardening resin layer is formed on the first optical recording layer, and the resin layer is hardened by irradiating the ultraviolet rays. Then, a stamper having a minute unevenness is pushed against the surface of the hardened resin layer to transcript a second unevenness shape onto the surface of the hardened resin layer. Subsequently, a second optical recording layer is formed on the second unevenness shape of the hardened resin layer, and a protection layer is formed on the second optical recording layer.

Also, a method of manufacturing an optical information recording medium is disclosed in Japanese Laid Open Patent Publication (JP-P2004-220750A). In this conventional manufacturing method of the optical information recording medium, a substrate having a central hole and having a recording layer on a main surface is prepared, and the central hole is blocked up with a hole stoppage member. Resin material is dropped from above the central hole while turning the substrate around the central hole to apply the resin material onto the recording layer by a spin coating method. The hole stoppage member is removed from the central hole, a stamper having a ditch or an unevenness pit is prepared and fit to oppose to the resin material on the substrate. An intermediate layer is formed of the resin material through the hardening the resin material, and the stamper is removed from the substrate. Thus, the recording layer is formed on the surface of the intermediate layer to correspond to the ditch or unevenness pit of the stamper.

### SUMMARY OF THE INVENTION

It is an object of the present invention to provide a multi-layer optical information recording medium from which a reproduction signal having excellent quality can be obtained, and an information reproducing apparatus for the recording medium.

In an aspect of the present invention, there is provided with an optical information recording medium to which a recording operation or reproducing operation of information is carried out by irradiating a laser beam. The optical information recording medium includes two recording layers provided through a space layer. An absolute value of a change Δd of a film thickness of the space layer for every unit length in a circumferential direction is equal to or less than a predetermined value which is determined based on a wavelength of the laser beam, a refractive index of the space layer in the wavelength λ and one of a line velocity of the laser beam and the shortest pit length in a pit sequence recorded in each of the recording layers.

Here, when the wavelength of the laser beam is λ, the refractive index of the space layer in the wavelength λ (μm) is n, and a standard line velocity of the optical information recording medium is v (m/s), the change Δd of the film thickness of the space layer per 1 mm in the circumferential direction is |Δd|≦(10λ/n/v).

Also, when the wavelength of the laser beam is λ, the refractive index of the space layer in the wavelength λ (μm) is n, and the shortest pit length of the pit sequence recorded on each of the recording layers of the optical information recording medium is L (μm), the change Δd of the film thickness of the space layer per 1 mm in the circumferential direction is |Δd|≦0.309λ/n/L.

Also, the film thickness of the space layer is in a range of 20 μm to 40 μm.

In another aspect of the present invention, there is provided with an optical information recording medium to which a recording operation or reproducing operation of information is carried out by irradiating a laser beam. The optical information recording medium includes N recording layers (N is a natural number more than 2); and (N−1) space layers, each of which is provided between every adjacent two of the N recording layers. An absolute value of a change Δd of a film thickness of each of the N space layers for every unit length in a circumferential direction is equal to or less than a predetermined value which is determined based on a wavelength λ of the laser beam, a refractive index of the space layer in the wavelength λ and one of a line velocity of the laser beam and the shortest pit length in a pit sequence recorded in each of the recording layers.

Here, when the wavelength of the laser beam is λ (μm), the refractive index of the space layer in the wavelength λ (μm) is n, and a standard line velocity of the optical information recording medium is v (m/s), the change Δd of the film thickness of each of the n space layers per 1 mm in the circumferential direction is |Δd|≦(5λ/n/v).

Also, when the wavelength of the laser beam is λ (μm), the refractive index of the space layer in the wavelength λ (μm) is n, and the shortest pit length of the pit sequence recorded on each of the recording layers of the optical information recording medium is L (μm), the change Δd of the film thickness of the space layer per 1 mm in the circumferential direction is |Δd|≦0.154λ/n/L.

In another aspect of the present invention, there is provided with an optical information recording medium to which a recording operation or reproducing operation of information is carried out by irradiating a laser beam. The optical information recording medium includes M recording layer (M is a natural number more than 2); and (M−1) space layers, each of which is provided between every adjacent two of the N recording layers. When a film thickness of N-th one (1≦N≦M−2) of the (M−1) space layers from a laser incidence plane is d_{N}, a film thickness of (N+1)-th one of the (M−1) space layers is d_{N+1}, and a difference in the film thickness of the space layer is DS=|d_{N}−d_{N+1}|, the absolute value of the change ΔDS of the space film thickness difference DS for every unit length in a circumferential direction is equal to or less than a predetermined value.

Here, when the wavelength of the laser beam is λ (μm), the refractive index of each of the N-th and (N+1)-th space layers in the wavelength λ (μm) is n, and a standard line velocity of the optical information recording medium is v (m/s), the change Δd of the film thickness of the space layer per 1 mm in the circumferential direction is |Δd|≦(5λ/n/v).

Also, when the wavelength of the laser beam is λ (μm), the refractive index of each of the N-th and (N+1)-th space layers in the wavelength λ (μm) is n, and the shortest pit length of pit strings recorded on each recording layer of the optical information recording medium is L (μm), the change ΔDS of the film thickness DS of the space layer per 1 mm in the circumferential direction is |ΔDS|≦0.154λ/n/L.

Also, the wavelength of the laser beam is in a range of 380 to 430 nm and the laser beam collected by an object lens with an aperture of 0.6 to 0.7 is irradiated to the optical information recording medium.

Also, the information which is ETM (Eight to Twelve Modulation) modulated is recorded on the optical information recording medium.

Also, in still another aspect of the present invention, there is provided with an optical information reproducing apparatus which carries out reproduction of information by using the above optical information recording medium. The optical information reproducing apparatus includes an optical head section configured to irradiate the laser beam to the optical information recording medium and to generate a reproduction signal from light reflected from the optical information recording medium; an amplifier section configured to amplify the reproduction signal; and a restraint section configured to restrain a change of the reproduction signal in a KHz band.

Here, the restraint section includes a high-pass filter configured to filter a signal outputted from the amplifier section, and a cutoff frequency of the high-pass filter is equal to or higher than 3 KHz and equal to or lower than 20 KHz.

### BRIEF DESCRIPTION OF THE DRAWINGS

FIGS. 1A and 1B are views showing a reproduction signal of an optical information recording medium according to the present invention;

FIG. 2 is a diagram showing an example of a configuration of a multi-layer optical information recording medium;

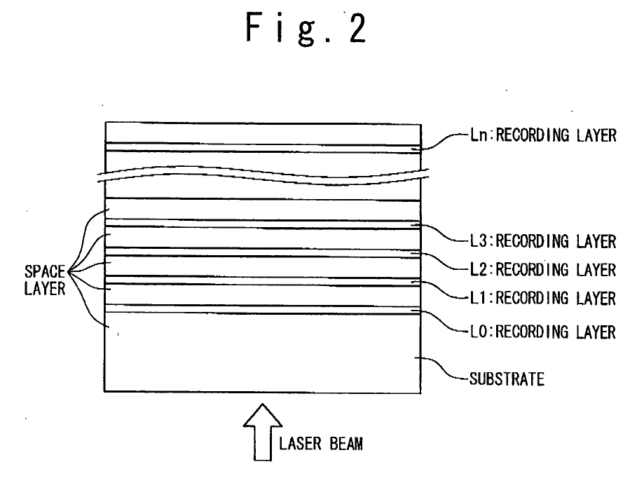

FIG. 3 is a diagram explaining inter-layer crosstalk in the multi-layer optical information recording medium;

FIG. 4 is a block diagram schematically showing a configuration of an optical information reproducing apparatus according to the present invention;

FIGS. 5A and 5B are graphs showing examples of a space layer film thickness distribution and a space layer thickness variation per unit length; and

FIG. 6 is a diagram showing optical interference generated in reproduction of data from an optical information recording medium having three or more recording layers.

### DESCRIPTION OF THE PREFERRED EMBODIMENTS

Hereinafter, an optical information reproducing apparatus for using an optical information recording medium according to the present invention will be described in detail with reference to the attached drawings. The inventor of this application discovered that the quality of a reproduction signal from the multi-layer medium greatly depended on not only the thickness of a space layer but also a variation in its thickness. The present invention is based on this discovery.

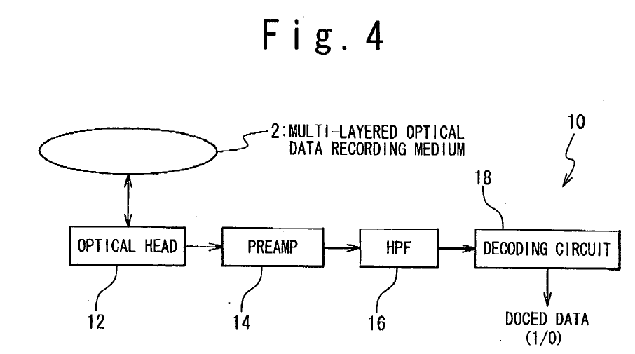

FIG. 4 is a block diagram showing a configuration of the optical information reproducing apparatus 10. With reference to FIG. 4, the optical information reproducing apparatus 10 includes an optical head section 12, a pre-amplifier 14, a high pass filter (HPF) 16 and a decoding circuit 18. In FIG. 4, other configurations such as a rotation system for rotating an optical information recording medium 2, a serve control system that are known to one skilled in the art are omitted.

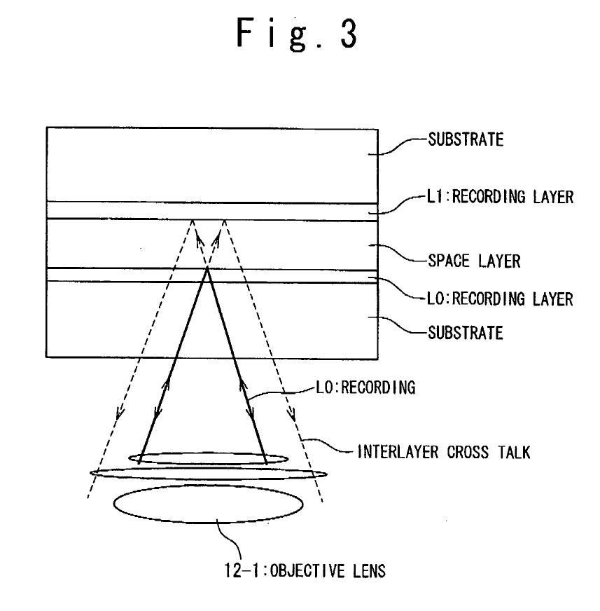

The optical head section 12 has the configuration known to the one skilled in the art and includes a laser diode (not shown) and an objective lens 12-1 (FIG. 3). A laser beam outputted and focused from the laser diode is irradiated to the multi-layer optical information recording medium 2. The optical head section 12 generates a reproduction signal from a reflection laser beam from the multi-layer optical information recording medium 2. The reproduction signal from the optical information recording medium is sent to the decoding circuit 18 through the pre-amplifier 14 for increasing a signal amplitude and the high pass filter 16 for suppressing noise of a low frequency component contained in the reproduction signal. The decoding circuit 18 is a circuit for converting the reproduction signal into a binary value. The decoding circuit 18 includes an AGC (automatic gain control) circuit for making the signal amplitude constant and a PLL circuit for clock signal extraction and the like (all of them are not shown). The decoding circuit 18 includes a comparator (not shown) when the binary value conversion is executed by using a level slice method, as known to the one skilled in the art, and also includes a PR equalizing circuit and a Viterbi detector (not shown) when the binary value conversion is executed by using a PRML method.

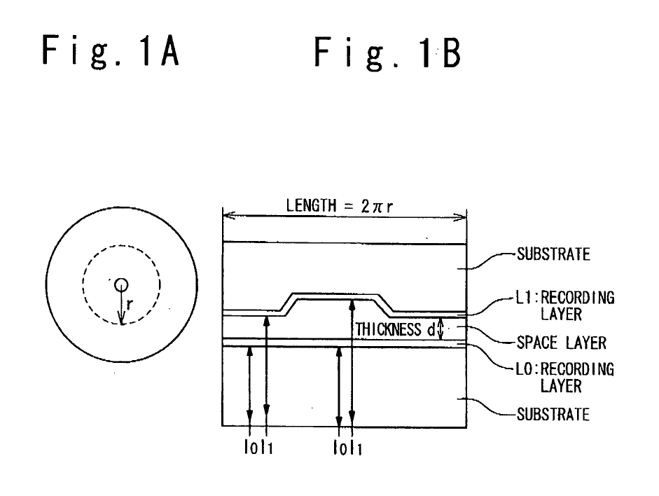

As an example in which the data is reproduced from a 2-layer optical information recording medium as the multi-layer optical information recording medium 2, the reproduction of a data signal from an L0 recording layer will be described in detail with reference to FIGS. 1A and 1B. When the data should be reproduced from the L0 recording layer at a position of a radius r from a center as shown in FIG. 1A, the focused laser beam is irradiated from the optical head section 12 and is reflected on the L0 recording layer and outputted as an optical reproduction signal 10 as shown in FIG. 1B. Also, the focused laser beam passes through the L0 recording layer and is reflected on an L1 recording layer and then outputted as an optical reproduction signal I1 after passing through the L0 recording layer again. The optical reproduction signal I1 reflected on the L1 recording layer functions as inter-layer crosstalk. The optical reproduction signal It containing the signals I0 and I1 is detected by a photo detector (not shown) of the optical head section 12. The optical reproduction signals I0 and I1 are beams having the spreads. However, they are indicated as straight lines in FIG. 1B, for the purpose of simple illustration.

The inventor of this application discovered that optical interference between the optical reproduction signals I0 and I1 caused the severe deterioration in the quality of the optical reproduction signal. An electric field amplitude of the optical reproduction signal I0 on the photo detector is defined as R0eiθ, and an electric field amplitude of the optical reproduction signal I1 is defined as R1ei(θ+ΔΦ). Then, when the optical interference is caused between the optical reproduction signals I0 and I1, the optical reproduction signal It after the interference is represented as
It=R02+R12+2R0R1 cos(ΔΦ).
Here, a wavelength of the laser beam used to reproduce the data is defined as λ, a refractive index of a space layer is defined as n, and a thickness of the space layer is defined as d. At this time, ΔΦ is represented as ΔΦ=2π×2nd/λ. The variation in the thickness of the space layer brings about the variation in Δφ and results in the variation in the optical reproduction signal It. The reproduction of the data from the optical information recording medium 2 is usually carried out along a pit string or guide groove formed in a concentric circle or a spiral shape formed on the optical information recording medium. Thus, when a film thickness distribution exists in a circumferential direction on the circle of the radius r shown in FIG. 1A, the variation in a light quantity occurs in the reproduction signal from the optical information recording medium 2. Thus, the film thickness distribution in the circumferential direction becomes one factor of the increase in an error rate when the data is reproduced. The space layer is usually made of ultraviolet hardening resin, and its refractive index (in the vicinity of a wavelength 400 nm) is about 1.5 to 1.6. It should be noted that the beams of the reproduction signals I0 and I1 are different in area and the optical phases of the reflection beams are not completely uniform. Therefore, the interference represented by the foregoing equation is not actually generated. However, the inventor of this application discovered that the optical interference resulting from the film thickness variation in the space layer caused the light quantity variation of about 5 to 15%, with respect to the total reception light reflection light quantity, and the signal quality was deteriorated.

An allowable film thickness variation in the circumferential direction can be estimated as following. It is supposed that the wavelength of the laser beam is λ (μm), a refractive index of the space layer in the wavelength λ is n, a line velocity of the laser beam when the data is reproduced is v (m/s), and a variation in the space layer thickness per 1 mm in the circumferential direction is Δd. In this case, if Δd=0.5λ/n/v, ΔΦ is changed by 2π in a range of v (mm) in the circumferential direction, and the light quantity variation of 1 KHz is caused (a time required when a beam moves over a length of v (mm) in the velocity v (m/s) is 1 ms, and a frequency of the light quantity variation with 1 ms as one period is 1 KHz). Similarly, if Δd=2.5λ/n/v, the variation in 5 KHz is caused, and if Δd=10λ/n/v, the variation of 20 KHz is caused. Here, the film thickness variation per 1 mm (corresponding to a film thickness variation inclination) is noticed. However, in usual space layer forming methods such as ultraviolet hardening resin layer formation through a spin coating and transparent sheet pasting by use of an adhesive, the film thickness is drastically varied in a range shorter than 1 mm in almost cases. Thus, it is adequate to consider the film thickness variation inclination per 1 mm.

The variation of a KHz band can be suppressed by the high pass filter 16. However, the signal recorded on the optical information recording medium 2 also contains a signal component in the KHz band. Thus, if a cutoff frequency of the high pass filter 16 is set to be excessively high, the reproduction signal itself is deteriorated. As described in the following examples, when the cutoff frequency of the high pass filter 16 is set to be higher than 20 KHz, the detection performance is deteriorated. Accordingly, the absolute value of the film thickness variation Δd per the length of 1 mm in the circumferential direction must be 10λ/n/v or less. Moreover, the high pass filter 16 of the cutoff frequency of 20 KHz cannot perfectly remove the variation component to 20 KHz. Therefore, preferably, it is equal to or less than 5λ/n/v corresponding to the variation 10 KHz, and more preferably, it is equal to or less than 2.5λ/n/v corresponding to 5 KHz or less.

It is possible to use an offset canceller by setting a variation in an average light reception level as an error signal and suppressing the variation through a closed loop, in addition to the high pass filter 16, in order to suppress the variation of the KHz band. Also, both of the high pass filter and the offset canceller may be used at the same time.

### First Embodiment

A polycarbonate (PC) having the thickness of 0.6 mm is used for a substrate. Then, layers of ZnS—SiO₂, GeCrN, GeSbTe, GeCrN, ZrS—SiO₂, Ag alloy and ZnS—SiO₂ are laminated on the PC substrate in this order, and the L0 recording layer is completed. The substrate on which the guide groove for the tracking serve has been formed is used for the PC substrate. The pitch of the guide groove is 0.4 μm, and the depth is 30 nm. Layers of Ag alloy, ZnS—SiO₂, GeSbTe, and ZnS—SiO₂ are laminated on a PC substrate in this order, and the L1 recording layer is completed. A 2-layer medium is formed by adhering the L0 recording layer and the L1 recording layer to each other by use of the ultraviolet hardening resin having the refractive index of n=1.58 in the wavelength of about 400 nm as a spacer layer. The thickness of the space layer is about 28 μm as an average value. The five 2-layer media having the same configuration were formed, and the relation between the film thickness variation in the space layer and the record/reproduction property was examined. When the five media were formed, the adhesion condition was intentionally changed such that the film thickness distribution of the disc in the circumferential direction was great.

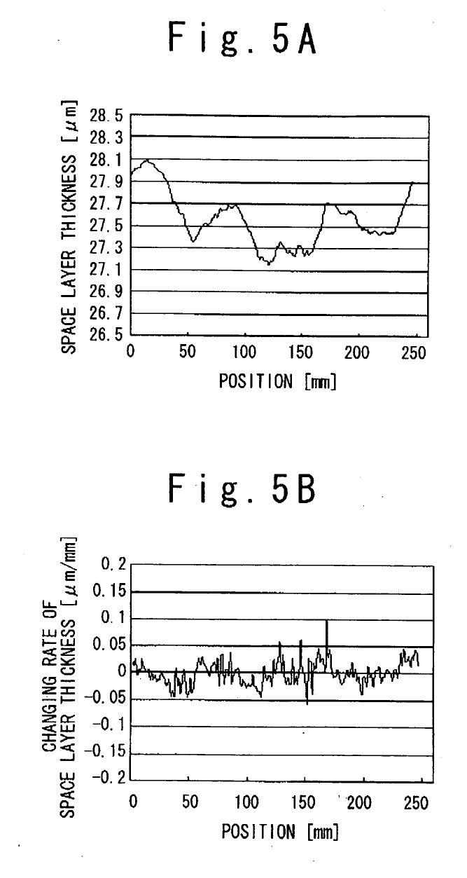

FIGS. 5A and 5B show an example of the film thickness distribution of the space layer in the circumferential direction. In this measurement example, at a radius of 39.5 mm (one round of 248.1 mm), a film thickness interference indicator was used to measure the space layer thickness for every 2 degrees (for each 1.379 mm), in the circumferential direction. Based on these measurement results, the film thickness variation and the film thickness variation inclination per 1 mm in circumferential direction are calculated.

The record/reproduction evaluation was carried out by using an optical head with an objective lens having the aperture (NA) of 0.65. At this time, the input surface of the laser beam was set on the side of the L0 recording layer. The line velocity at the time of the record/reproduction was set to 661 m/s, and the data subjected to an ETM (Eight to Twelve Modulation) modulation (“Eight to Twelve Modulation Code for High Density Optical Disk”, the reproduction signal ISOM '03 Technical Digest P. 160-161) was recorded at the clock frequency of 64.8 MHz (the shortest mark 2T: 0.204 [μm]). The reproduction was carried out by setting the cutoff frequency of the high pass filter 16 to 3 kHz and combining PR (1, 2, 2, 2, 1) equalization and Viterbi detection.

The following table 1 shows the relation between the film thickness variation (the film thickness variation inclination) per circumferential direction 1 mm of the space layer and the bit error rate at the time of the recording to and reproduction from the L0 recording layer. The film thickness variation shown in the table 1 is the value defined in the maximum value of the film thickness variation absolute value in one cycle. The table 1 shows the result of the formed five two-layer media.

TABLE 1

| Reproduction | Film Thickness | |
|---|---|---|
| Signal ID | Variation (μm/mm) | Bit Error Rate |
| 1 | 0.02 | 8 × 10⁻⁶ |
| 2 | 0.03 | 8.5 × 10⁻⁶ |
| 3 | 0.1 | 3.1 × 10⁻⁵ |
| 4 | 0.2 | 7 × 10⁻⁵ |
| 5 | 0.4 | 3 × 10⁻⁴ |

From the table 1, it could be seen that the bit error rate is extremely increased at the media 4 or media 5 in which the film thickness variation per 1 mm is great. In the signal variation frequency of 1 KHz in the evaluation condition of this embodiment, the film thickness variation per 1 mm is Δd=0.5×0.405/1.59/6.61=0.02 μm. Thus, in the medium 4 or medium 5, the signal variation between 10 KHz and 20 KHz is caused (the signal variation caused due to optical interference between the L0 recording layer reflection light and the L1 recording layer reflection light). It is considered that this variation caused the increase in the bit error rate. In the medium 5 corresponding to the variation frequency of 20 KHz, the bit error rate reaches 3×10⁻⁴ which is the allowable limit of an apparatus stable operation. Thus, it could be understood that the variation frequency is required to be set to 20 KHz or less. Moreover, if the variation frequency can be preferably set to 10 KHz or less, more preferably to 5 KHz or less, the data can be reproduced at the sufficiently low error rate.

### Second Embodiment

A relation between the cutoff frequency of the high pass filter 16 and the bit error rate is examined by using the medium 1 formed in the first embodiment. The record/reproduction conditions except for the cutoff frequency of the high pass filter 16 were set to those of the first embodiment. In addition, the bit error rate was measured by changing the cutoff frequency of the high pass filter 16. The following table 2 shows the measurement result. From the table 2, it could be seen that the bit error rate is gradually increased when the cutoff frequency of the high pass filter 16 is set to be higher than 20 KHz. It may be considered that the increase in the bit error rate results from the fact that a high frequency (20 KHz or higher) component contained in the ETM-modulated signal is deteriorated by the high pass filter. In this way, the high pass filter effectively functions in order to suppress the signal variation caused due to the optical interference. However, the upper limit of the cutoff frequency is desired to be set to about 20 KHz.

| High Pass Filter Cutoff (KHz) | Bit Error Rate |
|---|---|
| 1 | 9 × 10⁻⁶ |
| 3 | 8 × 10⁻⁶ |
| 10 | 7.3 × 10⁻⁶ |
| 20 | 9.3 × 10⁻⁶ |
| 30 | 2 × 10⁻⁵ |

The upper limit of Δd is defined by using the line velocity as a parameter. However, a pit length of a pit recorded on the optical information recording medium can be used to define it. When the line velocity at the time of the reproduction is defined as v (m/s), the wavelength of the laser beam is defined as λ (μm), the refractive index of the space layer in the wavelength λ is defined as n and the film thickness variation of the space layer per 1 mm in a circumferential direction is defined as Δd (μm), a frequency f (KHz) of the signal variation caused due to the film thickness variation of the space layer is represented by f=2vnΔd/λ. The length when the beam is advanced for 1 ms (corresponding to the cycle of 1 KHz) at the line velocity of v (m/s) is v (mm). Since the film thickness variation per 1 mm in the circumferential direction is Δd (μm), the film thickness variation quantity generated in the range of v (mm) is vΔd (μm). The optical path difference is 2vΔd that is two times. A multiple value of the wavelength λ/n to this optical path difference is equivalent to the frequency of the signal variation.

On the other hand, when the line velocity is defined as v (m/s) and the shortest pit length in a pit string recorded on the optical information recording medium is defined as L (μm), a frequency fs of the shortest pit length is fs=0.5v/L (MHz). In the first embodiment, fs (MHz)=16.2 MHz. When the allowable variation frequency fc (KHz) is set as 20 KHz, fs/fc=16.2/20. Accordingly, fc=20fs/16.2=10v/(16.2L). Thus, in order satisfy f≦fc, it is adequate to satisfy the condition of 2vnΔd/λ≦(10v/16.2/L). That is, if Δd≦0.309λ/n/L, the variation frequency is 20 KHz or less, and if Δd≦0.154λ/n/L, the variation frequency is 10 KHz or less.

### Third Embodiment

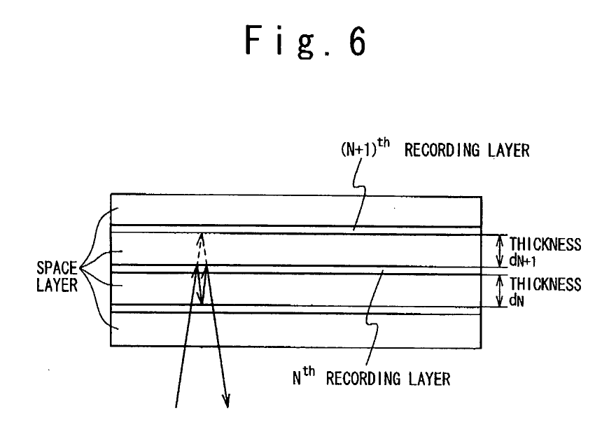

In the first and second embodiments, a case where the recording medium has the two recording layers has been described. However, when the recording medium has three or more recording layers, the optical interference is not caused by the variation in the single space layer, but by variation of the two space layers. That is, in case that the recording medium has three recording layers or more, new interference is caused in addition to the interference caused by the reflection beam between the layers adjacent to each other, similarly to the case of the two recording layers, as shown in FIG. 6. When the two or more recording layers exist on the input side of the target recording medium to which the data is recorded or from which the data is reproduced, the interference is caused as the result in which the laser beam is reflected on the recording layer one layer before, and is reflected on the rear of the recording layer two layers before, and is again reflected on the foregoing layer one layer before, and is returned to the optical head section 12.

If the thicknesses of the respective space layers are substantially equal, as for this interference light, the optical path length from the input surface is substantially equal to that of the targeted recording layer. Thus, even in the case of a small light quantity, the interference with the signal light corresponding to the information to be reproduced from the target recording layer becomes severe. Thus, its influence cannot be ignored. The difference between the two optical path lengths which contributes to the interference in this case is proportional to |d_{N}−d_{N+1}| where the film thickness of the N-th space layer when it is counted from the optical input side is defined as d_{N} and the film thickness of the (N+1)-th space layer is defined as d_{N+1}. Actually, this attainment is difficult. However, if the film thickness variation quantities in the circumferential directions of the respective space layers are perfectly equal, even if the film thickness itself is tentatively varied, the variation in the interference is never induced. Actually, since the film thickness variation in the circumferential direction is different for each space layer, a difference DS of the thickness between the N-th space layer and the (N+1)-th space layer is required to be DS=|d_{N}−d_{N+1}|, and a variation ΔDS per circumferential direction 1 mm of DS is required to be 10λ/n/v or less, preferably 5λ/n/v, and further preferably 2.5λ/n/v. If the film thickness variation itself of each space layer is suppressed to the half of the variation, the upper limit of the variation as mentioned above is automatically satisfied.

In this embodiment, the case of 28 μm as the thickness of the space layer has been described. However, the thickness of the space layer may be within the range between 20 μm and 40 μm. This is because if it is thinner than 20 μm, the deterioration in the signal quality caused by the inter-layer crosstalk cannot be ignored, and if it is thicker than 40 μm, the spherical aberration becomes greater, and the signal quality is deteriorated.

Also, in this embodiment, only the phase change recording medium has been described as the optical information recording medium. However, the effect of the present invention is similar in an optical information recording medium of a write-once read-many type and an optical information recording medium dedicated to reproduction.

Also, in this specification, only 0.65 has been described as the aperture NA of the objective lens in the optical head section 12. However, it is possible to use the optical head in the range between 0.6 and 0.7. In the aperture NA smaller than 0.6, it is impossible to reduce a beam diameter. Thus, it is difficult to carry out a high density recording. Also, in the aperture NA greater than 0.7, the allowable margin for a tilt of a disc when the laser beam from the substrate side is inputted to carry out the recording/reproducing operation is extremely narrow, and this is not practical.

If the aperture NA is greater than 0.7, the focus depth of the light collection beam becomes shallow. If the space layer is equal to or greater than 20 μm, the influence of the optical interference becomes at the substantially ignorable level. Thus, the case where the present invention functions effectively is the case when the optical head in which the wavelength is between 380 and 430 nm and the aperture of the objective lens is NA=0.6 to 0.7 is used to carry out the record or reproduction of the multi-layer optical information recording medium.

By using the present invention, the reproduction signal having the excellent quality can be obtained from the multi-layer media. Consequently, it is possible to provide a large capacity of the optical information recording medium.

What is claimed is:

1. An optical information recording medium to which an recording operation or reproducing operation of information is carried out by irradiating a laser beam, comprising:
two recording layers provided through a space layer,
wherein an absolute value of a change of a film thickness of said space layer for every unit length in a circumferential direction is equal to or less than a predetermined value which is determined based on a wavelength of said laser beam, a refractive index of said space layer in said wavelength and one of a line velocity of said laser beam and the shortest pit length in a pit sequence recorded in each of said recording layers.

2. The optical information recording medium according to claim 1, wherein when the wavelength of said laser beam is λ, the refractive index of said space layer in the wavelength λ (μm) is n, and a standard line velocity of said optical information recording medium is v (m/s), said change Δd of the film thickness of said space layer per 1 mm in the circumferential direction is |Δd|≦(10λ/n/v).

3. The optical information recording medium according to claim 1, wherein when the wavelength of said laser beam is λ, the refractive index of said space layer in the wavelength λ (μm) is n, and the shortest pit length of the pit sequence recorded on each of said recording layers of said optical information recording medium is L (μm), said change Δd of the film thickness of said space layer per 1 mm in the circumferential direction is |Δd|≦0.309λ/n/L.

4. The optical information recording medium according to claim 1, wherein the film thickness of said space layer is in a range of 20 μm to 40 μm.

5. An optical information recording medium to which an recording operation or reproducing operation of information is carried out by irradiating a laser beam, comprising:
M recording layers (M is a natural number more than 2); and
(M−1) space layers, each of which is provided between every adjacent two of said M recording layers,
wherein an absolute value of a change of a film thickness of each of said (M−1) space layers for every unit length in a circumferential direction is equal to or less than a predetermined value which is determined based on a wavelength of said laser beam, a refractive index of said (M−1) space layers in said wavelength, and one of a line velocity of said laser beam and the shortest pit length in a pit sequence recorded in each of said recording layers.

6. The optical information recording medium according to claim 5, wherein when the wavelength of said laser beam is λ(μm), the refractive index of said space layer in the wavelength λ (μm) is n, and a standard line velocity of said optical information recording medium is v (m/s), said change Δd of the film thickness of each of said n space layers per 1 mm in the circumferential direction is |Δd|≦(5λ/n/v).

7. The optical information recording medium according to claim 5, wherein when the wavelength of said laser beam is λ (μm), the refractive index of said space layer in the wavelength λ (μm) is n, and the shortest pit length of the pit sequence recorded on each of said recording layers of said optical information recording medium is L (μm), said change ad of the film thickness of said space layer per 1 mm in the circumferential direction is |Δd|≦0.154λ/n/L.

8. The optical information recording medium according to claim 5, wherein the wavelength of said laser beam is in a range of 380 to 430 nm and said laser beam collected by an object lens with an aperture of 0.6 to 0.7 is irradiated to said optical information recording medium.

9. The optical information recording medium according to claim 5, wherein said information which is ETM modulated is recorded on said optical information recording medium.

10. An optical information recording medium to which an recording operation or reproducing operation of information is carried out by irradiating a laser beam, comprising:
M recording layer (M is a natural number more than 2); and
(M−1) space layers, each of which is provided between every adjacent two of said M recording layers,
wherein when a film thickness of N-th one (1≦N≦M−2) of said (M−1) space layers from a laser incidence plane is d_{N}, a film thickness of (N+1)-th one of said (M−1) space layers is d_{N+1}, and a difference in the film thickness of the space layer is DS=|d_{N}−d_{N+1}|, the absolute value of said change ΔDS of said space film thickness difference DS for every unit length in a circumferential direction is equal to or less than a predetermined value.

11. The optical information recording medium according to claim 10, wherein when the wavelength of said laser beam is λ (μm), the refractive index of each of said N-th and (N+1)-th space layers in the wavelength λ (μm) is n, and a standard line velocity of said optical information recording medium is v (m/s), said change Δd of the film thickness of said space layer per 1 mm in the circumferential direction is |Δd|≦(5λ/n/v).

12. The optical information recording medium according to claim 10, wherein when the wavelength of said laser beam is λ (μm), the refractive index of each of said N-th and (N+1)-th space layers in the wavelength λ (μm) is n, and the shortest pit length of pit strings recorded on each recording layer of said optical information recording medium is L (μm), said change ΔDS of the film thickness DS of said space layer per 1 mm in the circumferential direction is |ΔDS|≦0.154λ/n/L.

13. The optical information recording medium according to claim 10, wherein the wavelength of said laser beam is in a range of 380 to 430 nm and said laser beam collected by an object lens with an aperture of 0.6 to 0.7 is irradiated to said optical information recording medium.

14. The optical information recording medium according to claim 10, wherein said information which is ETM modulated is recorded on said optical information recording medium.

15. An optical information reproducing apparatus which carries out reproduction of information by using the optical information recording medium, comprising:
an optical head section configured to irradiate said laser beam to said optical information recording medium and to generate a reproduction signal from light reflected from said optical information recording medium;
an amplifier section configured to amplify said reproduction signal; and
a restraint means for restraining a change of said reproduction signal in a KHz band.

16. The optical information reproducing apparatus according to claim 15, wherein said restraint means comprises a high-pass filter configured to filter a signal outputted from said amplifier section, and
a cutoff frequency of said high-pass filter is equal to or higher than 3 KHz and equal to or lower than 20 KHz.
